(19) United States
(12) Patent Application Publication
(10) Pub. No.: US 2008/0155457 A1
(43) Pub. Date: Jun. 26, 2008

(54) Embedding visual content of an embedder in an embedded component

(75) Inventor: Jens Ittel, Limburgerhof (DE)

Correspondence Address: MINTZ, LEVIN, COHN, FERRIS, GLOVSKY & POPEO, P.C.;ATTN: PATENT INTAKE CUSTOMER NO. 64280, ONE FINANCIAL CENTER, BOSTON, MA, 02111, US

(73) Assignee: SAP AG

(21) Appl. No.: 11/643,420

(22) Filed: Dec. 20, 2006

(51) Int. Cl. G06F 3/048

(52) U.S. Cl. 715/781

(57) ABSTRACT

In one aspect, there is provided a computer-implemented method enabling the implementation of reusable components in a framework, such as a model-view-controller (MVS) framework. The method may implement an embedder component and an embedded component in the reusable component framework. A first view area of a first interface view of the embedded component is mapped to a second view area of the embedded component. Visual content is provided from the embedder component to the embedded component using the first view area of the interface view of the embedded component and the second view area. Related systems, apparatus, methods, and/or articles are also described.

### FIELD

The subject matter described herein relates to application programming including user interfaces.

### BACKGROUND

Advances or changes in how enterprises conduct business result from, for example, growing competition and globalization, mergers and acquisitions, or a revamping of business models. Successful advances and changes often depend on how quickly the enterprise's information technology (IT) organization adapts to evolving business needs.

One advancement is the development of applications using various architectures, including, for example, a model-view-controller (MVC) architecture. The MVC architecture breaks an application into three separate parts—models, views, and controllers. Each model can have multiple views, where each view displays information about the model to a user. A controller of the model receives events, for example, raised by a user interacting with a view to manipulate the model. Each model can have multiple controllers, and a controller can relate to multiple views. The models and the controllers typically include application code. When changes occur in a model, the model updates its views. Data binding is used for data transport between the view and its model or controller. For example, a table view can be defined to display data of a corresponding table that is stored in the model or controller. The table is used as the data source for the table view (data binding). For example, the table view can be replaced by a further view, such as a graph view, that binds against the same table. In this case, the further view displays the table data without changing anything in the controller or the model. Examples of MVC frameworks including components and views are depicted in U.S. patent Publication Ser. No. 2005/0071749, filed Feb. 17, 2004, entitled “Developing and Using User Interfaces With Views,” and U.S. patent Publication Ser. No. 2005/0071850, filed Sep. 30, 2003, entitled “Software Component Architecture,” both of which are incorporated herein by reference.

Application development is often divided into two general stages: design time and runtime. Design time can include designing the views of an application (including the layout of the user interface (UI) elements in each view), modeling of the application flow (including the selection of the views to displayed), designing one or more models, and creating and editing other application elements, such as controllers and contexts. Design time can also include the binding of UI elements within the views to data sources that are defined in a data type repository.

Information created during the design time can include application metadata. Application metadata can be stored in a metadata repository, and used as input to the runtime process. During the runtime process, the application metadata can be used to generate the actual runtime code of an application. In some implementations, the application metadata is platform independent, and the generated runtime code is platform specific. The runtime code can be executed in a runtime environment that provides a general framework for running applications. For example, a runtime environment can provide services for deploying and maintaining applications, as well as features such as a caching mechanism that can be used to improve performance, and automatic input assistance and default error handling that is based on the declared application metadata.

Regardless of which architecture is used, it is often desirable to structure an application (including, for example, the models, views, and controllers that make up an MVC application) into reusable entities or components. The reusable components can be embedded by the application, or by another reusable component.

### SUMMARY

In one aspect, there is provided a computer-implemented method. The method may enable the implementation of reusable components in a framework. The method may include implementing an embedder component and an embedded component in the reusable component framework. A first view area of a first interface view of the embedded component is mapped to a second view area of the embedded component. Visual content is provided from the embedder component to the embedded component using the first view area of the interface view of the embedded component and the second view area.

In some variations, the second view area is of a window. The first view area is mapped to the second view area of a window; the second view area is mapped to a third view area of a view included in the window. The embedder component may be selected from a plurality of components having a window. The first and second view areas may be mapped by graphically linking the view areas. The interface view is defined as having the first view area.

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

In some implementations of the subject matter described herein, advantages may be realized, such as lower cost user interface development and faster user interface development.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

In the drawings,

FIG. 1 is a block diagram of a development environment for developing an application program using reusable components;

FIG. 2A is a block diagram of a component;

FIG. 2B illustrates further features of a component;

FIG. 3 is a block diagram of a system for accessing an embedded component instance;

FIG. 4 is a block diagram of a view;

FIG. 5 illustrates a visual interface with multiple views that are linked together using navigation links;

FIG. 6 depicts an example of an embedder component and an embedded component;

FIG. 7 depicts a resulting view assembly for FIG. 6;

FIG. 8 depicts an additional example of an embedder component and embedded components;

FIG. 9 depicts view areas that are mapped to enable the exchange of visual content from an embedded component to an embedder component;

FIG. 10 depicts a resulting view assembly for FIG. 8; and

FIG. 11 depicts a method for implementing an embedder component that provides visual content to an embedded component by mapping a view area on an interface view of the embedded component and a view area of an embedded component, namely a view area of a window and a view area of view contained in the window.

### DETAILED DESCRIPTION

The subject matter described herein enables an embedder component (i.e., a component embedding another component or view) to provide visual content, such as a visual representation of the component, to an embedded component by defining a view area (also referred to as a view container) for the interface view of the embedded component.

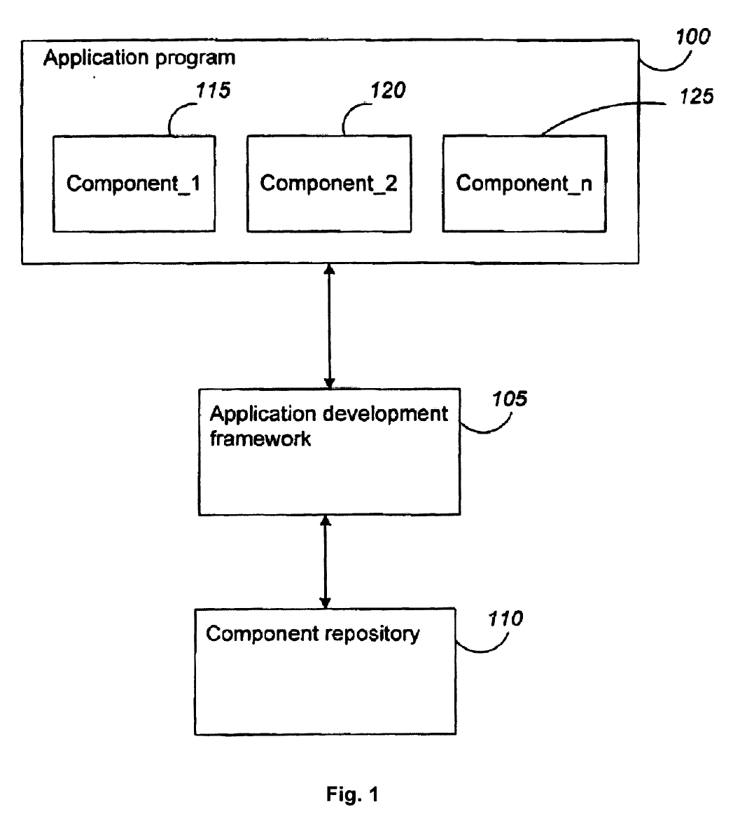

FIG. 1 is a block diagram of an environment for developing an application program 100 using reusable components. The development environment includes an application development framework 105 and a component repository 115. The application program 100 is developed using reusable components available in the component repository 110, e.g., components 115, 120, and 125. A component in the component repository 110 can have more than one instance, where the component instances are being used in multiple application programs. The application program 100 is developed at design time using the application development framework 105.

At runtime, the application runs within a runtime framework that provides the code required to create and manage the instances of the components used by the application program 100. As discussed below, the services provided by the runtime framework include component lifecycle management and managing component event subscriptions.

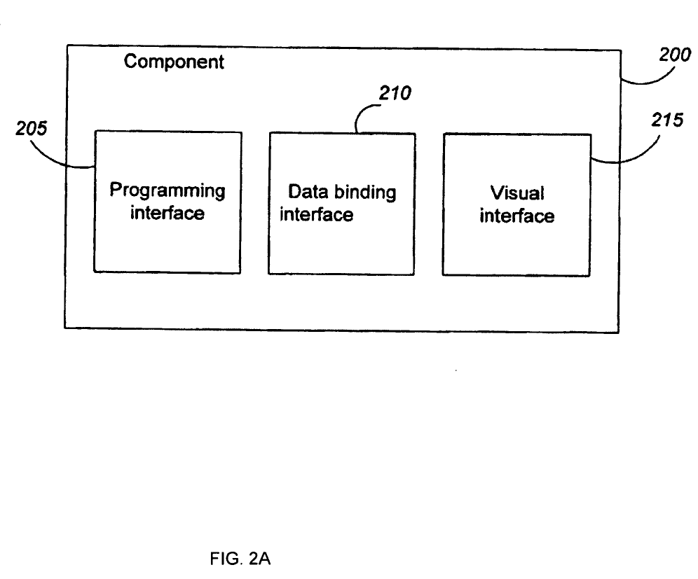

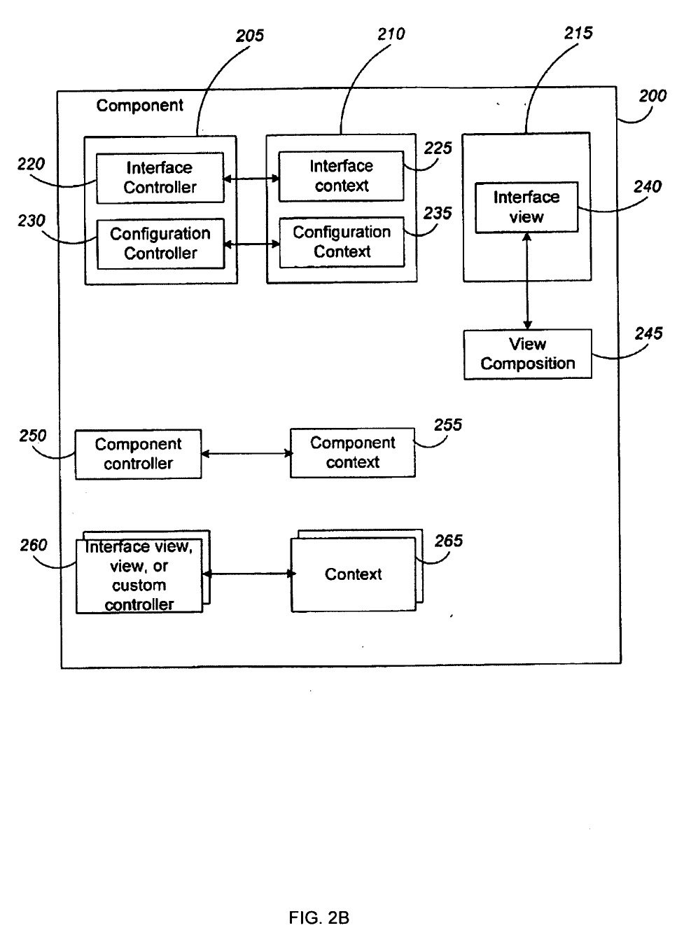

FIG. 2A is a block diagram of a component 200. The component 200 is a reusable entity providing functionality that can by used by many applications (or that can be used multiple times by the same application). The component 200 can be embedded, and it can have zero or more visual representations. A component having no visual representations cannot be displayed. An application or a component that embeds the component 200 is referred to as a component embedder for the component 200, and the component 200 is referred to as the embedded component.

The component 200 provides three separate interfaces—a programming interface 205, a data binding interface 210, and a visual interface 215.

The programming interface 205 is used by the component embedder to interact with the component 200. The component interface is an active component. The component interface is not just a signature. The component interface defines the component methods that are visible to the component embedder and routes the visible method calls to one or more component implementations.

The component embedder embeds the component 200 by programming to the programming interface 205, i.e., the component embedder can call methods provided by the programming interface 205. The programming interface 205 may be provided by a controller, referred to as a component interface controller or interface controller, so that the component embedder can interact with an embedded component through the interface controller of the embedded component.

The component 200 may also have one or more visual representations (which will be referred to as views). As described below, a component embedder can access and use the views of the component 200 (for example, to form its own view) through a visual interface 215.

The data binding interface 210, described below, is used by a component embedder to exchange data with the component 200.

In one implementation, the component 200 may include one or more controllers, one or more associated contexts, and one or more views. The controllers are used to implement the logic of the component, and the views provide a visual representation of the component. A component can include multiple types of controllers, as described below. The controllers may implement event handlers that are executed in response to an action performed by a user, e.g., pressing a button or making a menu selection. Each controller is bound to an associated context. A context is a local data structure for a controller that stores data and state specific to the controller.

FIG. 2B illustrates further features which may be implemented in connection with component 200.

The programming interface 205 for the component 200 further includes an interface controller 220 and a configuration controller 230. The interface controller 220 implements methods that can be used (e.g., by a component embedder) to interact with the component 200. The configuration controller 230 provides access to configuration data for the component 200. The interface controller 220 has an associated data binding interface 210 comprising interface context 225 for storing data and state for the interface controller 220.

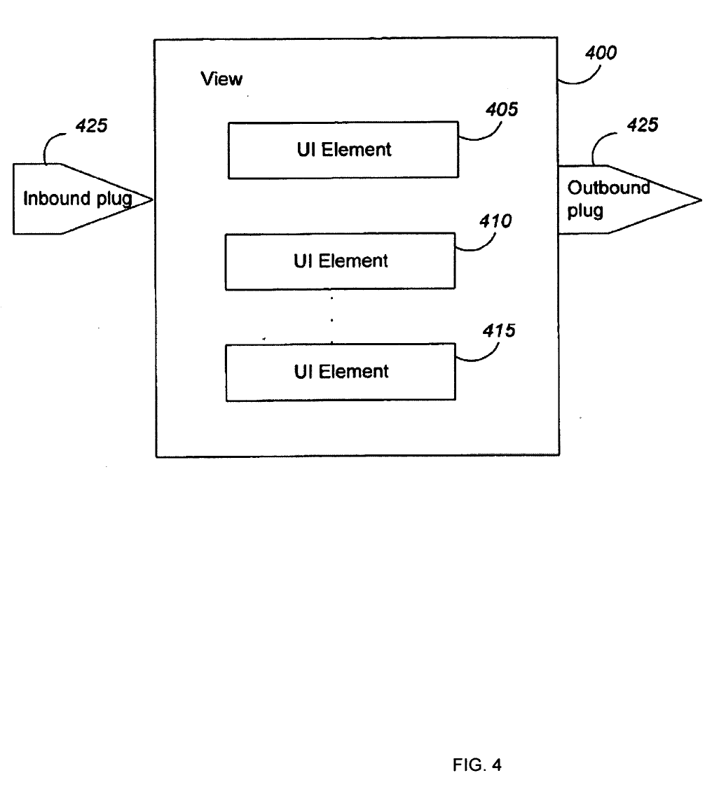

FIG. 4 is a block diagram of a view. A visual interface of a software application is made up of one or more views arranged in a specific layout. A view 400 specifies a layout of at least one user interface element (UI) element 405. UI elements in a view can include buttons, labels, menus, and the like.

As used herein, a view area defines the area to be occupied by a view, such as view 400, in a visual interface 215 embedding the view 400. The UI elements included in the view 400 can include input UI elements, view UI elements, and container UI elements. An input UI element is used to receive input from the user, e.g., a drop down menu, an input field, or a table UI element. A view UI element is used to display application data, e.g., an image view, a text view, or a caption. A container UI element, described below, is used to include other views and UI elements, e.g., a scroll container UI element having a scroll bar, or a container UI element specifying a layout for included views.

The visual interface 215 can have more than one view, of which only some views are visible at any time. The views that are visible in the visual interface can change, e.g., the views that are visible can change in response to input from the user. Inbound plugs, outbound plugs, and navigation links are design time constructs that are used by application developer to specify transitions between the views. Each view has zero to many inbound plugs, such as inbound plug 420, and zero to many outbound plugs, such as outbound plug 425. At design time, each navigation link establishes a potential transition from the view with the outbound plug 425 to the view with the inbound plug 420. At design time, a transition from a first view to a second view is specified by connecting the outbound plug 425 of the first view to the inbound plug of the second view. The navigation links are processed at runtime to cause the view transitions specified at design time. At run time, the application calls the outbound plug of the first view to cause a transition from the first view to the second view.

Each inbound plug 420 includes an application specific event handler, and calling the inbound plug results in running the event handler for the inbound plug 420 before displaying the view 400 corresponding to the inbound plug 420. Navigation links are typically processed in a runtime framework by calling all the inbound plugs 420 connected to an outbound plug 425 when the outbound plug 425 is called. The event handler for an inbound plug 420 can call the outbound plug 425 for the view corresponding to the inbound plug to cause other views connected to the outbound plug 425 to be displayed. The application can use the event handler for the inbound plug 420 to initialize the corresponding view, e.g., the corresponding view can be initialized based on why the view is being displayed.

The view 400 can have an associated view controller that includes the event handlers associated with the inbound plug. The view controller also contains event handlers for the UI elements in the view as well as the presentation logic for the view.

The application or a reusable component can specify any number of views at design time, any of which can be displayed at runtime. The set of views that can be displayed, for the application or the component, is referred to as the view composition. A view assembly is the set of views that are actually displayed at runtime. The view assembly, for an application or a component, consists of views in the view composition that selected for display at a certain point in time. When a navigation link is processed at runtime, a view in a current view assembly may be replaced by one or more destination views from the view composition.

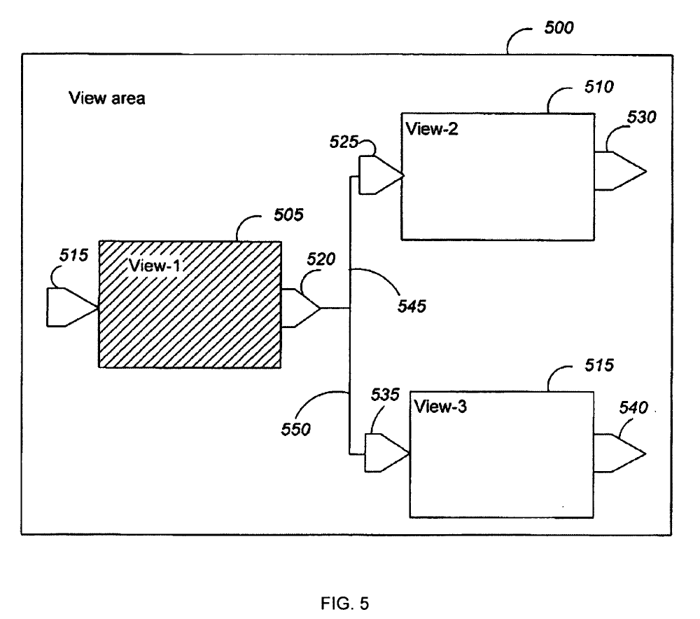

FIG. 5 illustrates a visual interface 500 with multiple views that are linked together using navigation links. Each navigation link connects an inbound plug to an outbound plug. The view area 500 includes three views 505, 510, and 515, of which view 505 is currently displayed in the view area 500. View 505 has inbound plug 515 and outbound plug 520. View 510 has inbound plug 525 and outbound plug 530. View 515 has inbound plug 535 and outbound plug 540. Outbound plug 520 is connected to inbound plug 525 by a navigation link 545, and outbound plug 520 is connected to inbound plug 535 by a navigation link 550. If view 505 activates outbound plug 520 by triggering the specified event for the outbound plug 520, views 510 and 515 are displayed in the view area 500 instead of the view 505.

Applications can make use of components that contain view compositions. Components can embed other components, such that a first embedder component can interact and make use of a second, embedded, component. The view composition of the first component can include views of the second component.

A component developer designates one of the views in the view composition of the component as an interface view 240. The interface view 240, and the associated inbound plug and outbound plug, are the visual interface for the component 200. At design time, the component embedder can use navigation links to specify view transitions to the interface views 240 of embedded components 200 like any other view in the view composition of the component embedder. A component can present more than one visual interface by defining more than one interface view.

Moreover, the interface view may have the added feature of including a view area (e.g., a SAP WebDynpro view container), as described further below. By defining a view area on an interface view of an embedded component, the embedder component can provided visual content (e.g., a view or visual representation) to the embedded component by way of the view areas in a declarative manner.

Each view may have a view controller and a view context associated with the view controller. The view controller implements presentation logic implemented by the view such as triggering events in response to user interaction with user interface elements in the view. The view context stores data and state associated with the view controller. The view context can be used to communicate data between the view and any controller of the component 200 by mapping the view context to the context of the controller.

Referring to FIG. 2B, the component 200 can also include a component controller 250 that implements common functionality required by views implemented by the component. The component controller 250 receives control when the component is instantiated, after the component instance has been initialized. The component 200 can also include one or more custom controllers 260, and associated contexts 265. The custom controllers 260 and associated contexts 265 are used to implement and structure functionality and data storage for the component 200.

The component embedder interacts with the embedded component 200 by using the programming interface 205, the data binding interface 210, and the visual interface 215. The embedded component 200 can interact with the component embedder by generating events. The component embedder can subscribe to events generated by the embedded component 200, and react to such events. Moreover, the visual interface 215 of the embedded component may include an interface view defined to further include a view area. By defining a view area on an interface view of the embedded component, the embedder component can provided visual content (e.g., a view or visual representation) to the embedded component in a declarative manner.

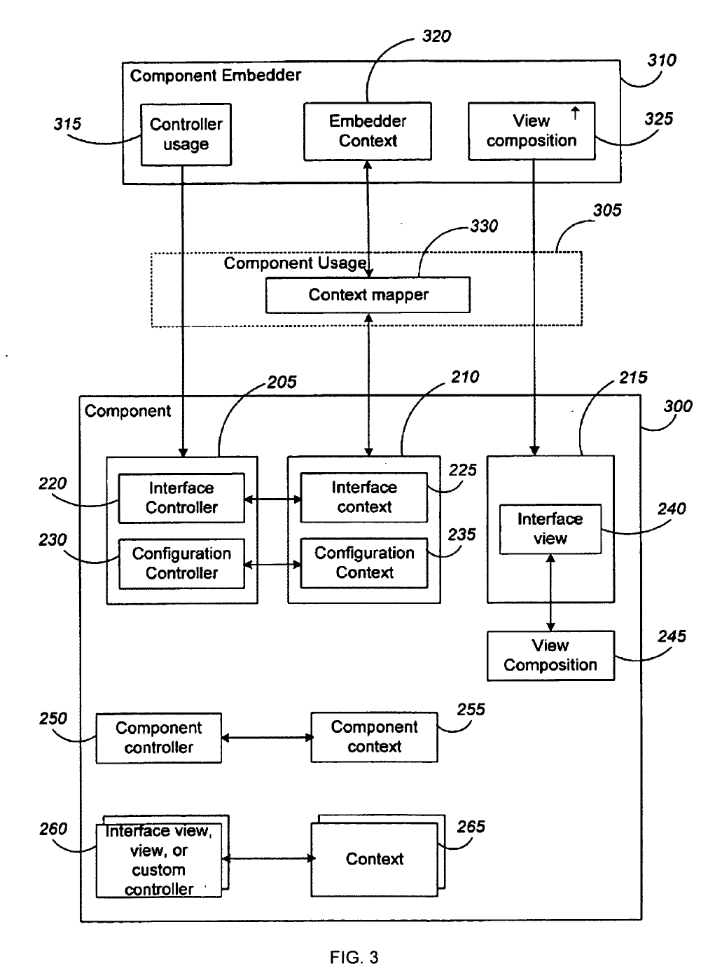

FIG. 3 is a block diagram of a component embedder 310 using an instance 300 of an embedded component 200, at runtime. The embedded component instance 300 is created at runtime. The embedded component 200 is reusable and several instances 300 of the embedded component 200 can be used at the same time. In the implementation shown in FIG. 3, the runtime framework 305 provides the services necessary for managing multiple component instances 300. Services provided by the runtime framework include the creation of component instances, e.g., using a component factory method to create component instances, and managing the lifecycle of component instances, e.g., deleting component instances embedded by a component embedder when the component embedder is deleted. Thus, neither the component embedder nor the embedded component 200 needs to include code for managing multiple component instances 300. Component usage object 305 is an object provided by the application development framework 105 to manage multiple component instances. Each component usage object 305 is associated with a component.

Component usage object 305 provides life-cycle management of the associated component 200 by providing methods for creating and deleting component instances 300 of the associated component 200 at runtime. The life-cycle of the component instance 300 is controlled by the component embedder 310. At design time an application programmer programs using a programming interface for a component without specifying a particular implementation of the component. The component programming interface used by the application programmer at design time is bound to a component implementation that provides the programming interface at run time. At run time, the component embedder 310 creates the component instance 300, implementing the component programming interface used by the component embedder, by calling the methods provided by the component usage object 305. The component usage object 305 responds to requests to create a component instance by selecting a component in the repository 110 that implements the desired programming interface and creating an instance of the selected component. Alternatively, if the application programmer specifies a component implementation at design time, an instance of the specified component can be created and used at runtime.

The runtime framework 115 uses component usage object 305 to access the programming interface of the associated component. The component usage object 305 is also used to manage event subscriptions for the associated component. In an implementation where a component embedder can subscribe to events generated by embedded components, the component usage object 305 caches the event subscriptions for subscribing component, if there is no instance of the subscribing component (because the subscribing component has not been created or because it has been deleted). In such a situation, the event subscriptions are delivered to the subscribing component when the subscribing component is instantiated.

Component usage object 305 includes a context mapper 330 that maintains context mappings between the component embedder 310 and the component instance 300. The component usage object 305 caches specified context mappings for components that has not been instantiated, and creates the specified context mappings for the component after the component has been instantiated.

Context is a local data structure for a controller that stores data and state specific to the controller. Controllers within a component, i.e., the interface controller, the configuration controller, the component controller, custom controllers, and view controllers, communicate data by mapping contexts.

The data binding interface allows the component embedder 310 to communicate data with the embedded component 300 by mapping the interface context 225 and the configuration context 235 using the context mapper 330. For example, the data binding interface enables mapping between components, views, windows, and the like.

The view composition 325 is implemented to also allow the component embedder 310 to provide visual content to the embedded component 300 by using a view area of the interface view 240.

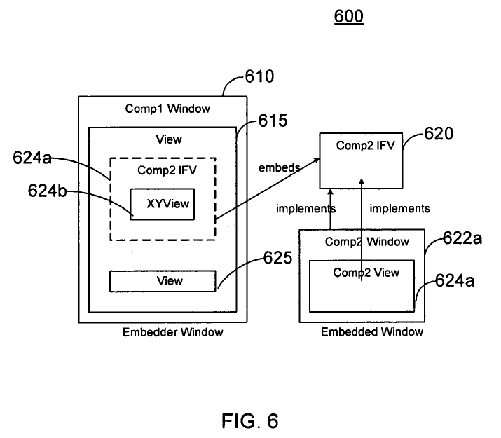

FIG. 6 depicts the window 610 of an embedder component and an embedded component interface view 620. Window 610 includes view 615. A window is visual representation including one or more views representing the view composition at runtime. It optionally can implement one or more interface views. It has an associated window controller. The view 615 may be considered a so-called root view. The root view is a view of content comprising one or more other views (or components) arranged in a hierarchy. For example, a designer of a user interface may define window component 610 to include a view and then define the view to include an arrangement of other views. The view 615 of FIG. 6 is an example of a root view since it depicts a hierarchy, namely interface view 620 and view 625 and is not contained in any other view within its window.

The interface view 620, of an embedded component, behaves like a view, but includes the added feature of transporting visual content from the embedder component into the embedded content and vice versa. Visual content is transported from the embedded component to the embedder component by making the content part of the window implementing the interface view and by including the interface view on the window of the embedder component. The interface view is defined as being on the window. Visual content is transported from the embedder component into the embedded component by putting the content into a view area of the interface view and mapping that view area in the embedded component as described below. The view area of interface view 620 may thus be used to provide a visual representation (e.g., visual content) to the component embedded in interface view 620. As a result, embedder window 610 may provide visual content (e.g., XYView 624b) to the defined view areas of embedded interface view 620. Moreover, interface view 620 may implement a view area as a mechanism for enabling the embedder component 610 to provide visual content to an embedded component, e.g., interface view 620.

The view area of interface view 620 can map (as well as declare the type on visual content provided to embedded component interface view 620, window 622a, and/or view 624a. By providing view areas, the embedder component (in this case window 610) can provide, at runtime, content to the embedded interface view 620, window 622a, or view 624a.

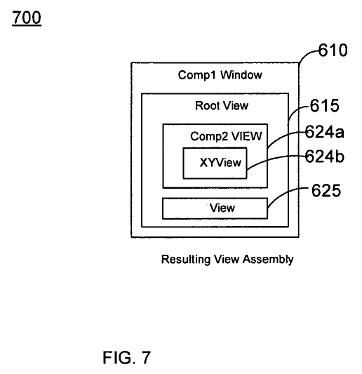

FIG. 7 depicts the view assembly 700 of window 610 of the embedder component of FIG. 6. Referring to FIG. 7, the embedder window component 610 includes view 615, embedded component (i.e., view 624a), and view 625. The view 624a includes a view area, which displays view 624b. The view area of interface view 620 (mapped to the view area of view 624a) is the mechanism for declaring visual content, so that it can be provided (i.e., transported) to the embedded component's interface view 620 (as well as window 622a and view 624a).

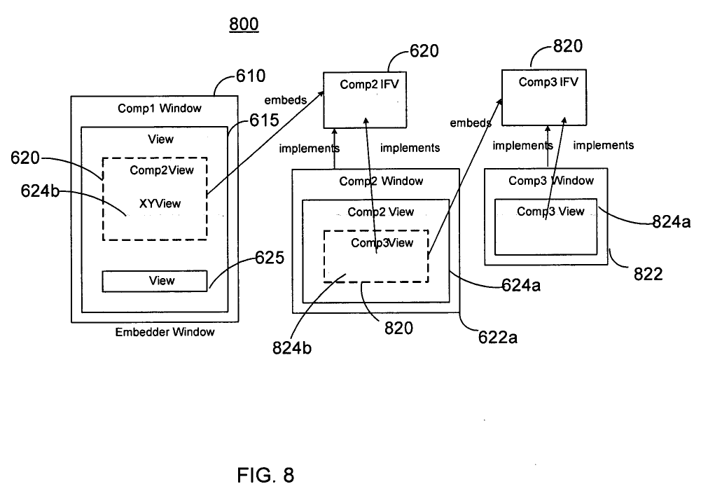

FIG. 8 is similar to the implementation of FIG. 6, but FIG. 8 depicts a window 610 (of the embedder component) embedding interface view 620 (of the embedded component to 610, and embedder component to 820), while interface view 620 embeds another interface view 820. The view areas of component interface view 820 may be mapped to view areas of interface view 620 and window 622a.

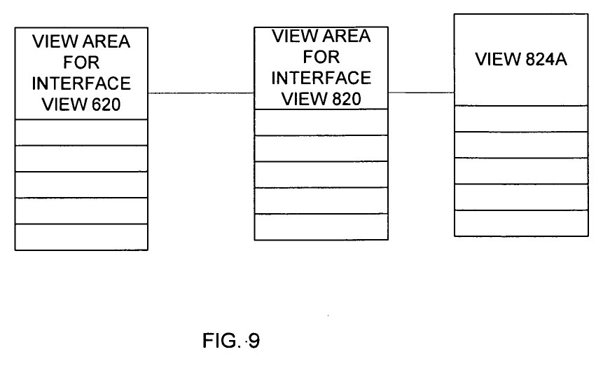

FIG. 9 depicts an example mapping of the view areas of FIG. 8. The view area for view 824a may be mapped to the view area of interface view 820 (or window 822). The view area of interface view 820 in turn may be mapped to the view area of interface view 620 (or window 622a), integrating the views while maintaining their independence by passing visual content of the components. The mapping may be performed using a model-based user interface development framework that allows the view areas to be linked graphically (or visually), so that at runtime the parameters of the view areas are declared and linked, although other implementations may be used that do not require graphical linking.

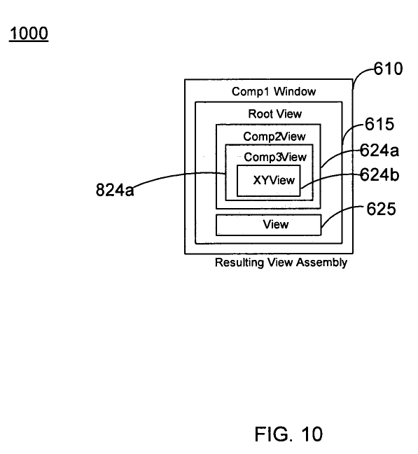

FIG. 10 depicts the resulting view assembly 1000 of FIG. 8. Referring to FIG. 10, the components form a window 610 including view 615, view 624a, and view 625. The view 824a (of interface view 820) is embedded within view 624a (of interface view 620). In this example, visual content XYView 624b is provided through view areas of interface views 620 and 820, so that the visual content can be integrated into embedded view 824a (FIG. 8).

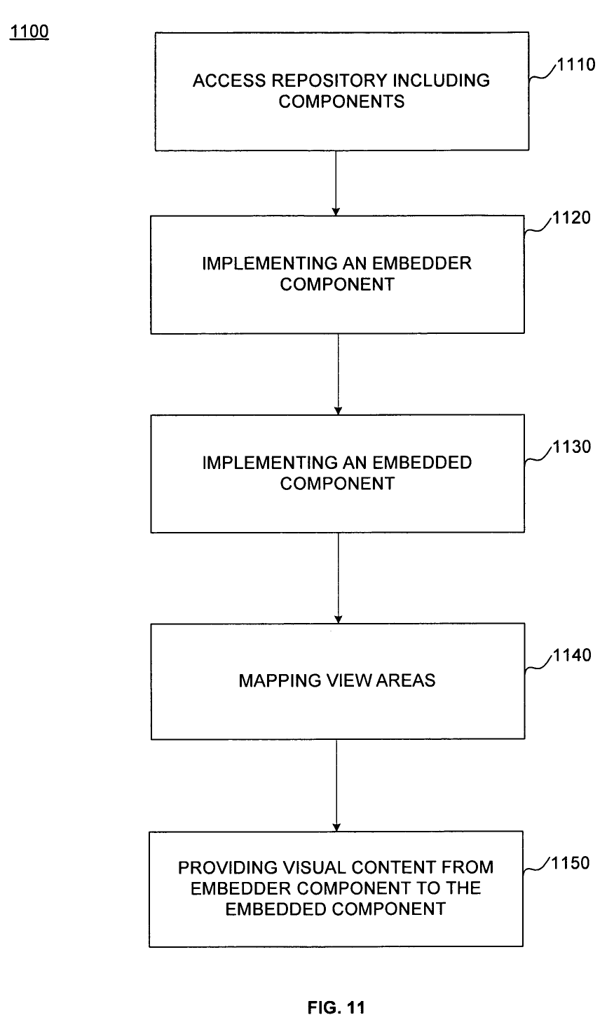

FIG. 11 depicts a method 1100 of implementing an embedded component including an interface view defined to further include a view area. At 1110, a user may access a component repository, including reusable components such as embedder components and embedded components including an interface view defined to include a view area. At 1120, an embedder component may be implemented in a framework, such as MVC framework. At 1130, an embedded component may be implemented. At 1140, the view area of the interface of the embedded component may be mapped to the view area of the embedded component. The mapping of view areas may also include mapping the view areas of additional embedded components. The mapping may be a graphical link or a pointer in memory that associates the view areas. Furthermore, the interface views of the embedded component may be made part of the view composition of the embedder component. At 1150, the embedder component provides visual content to the embedded component through a view area on an interface view of the embedded component.

The UI components described herein may be implemented with user interface design technology, such as SAP's WebDynpro, enabling a user to drag-and-drop components to form user interfaces, windows, and views (referred to as the “layout”), although other user interface design technology may be used as well. For example, the view areas may be implemented as view containers in WebDynpro.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results. Other embodiments may be within the scope of the following claims.

What is claimed is:

1. An article comprising a machine-readable medium embodying instructions that when performed by one or more machines result in operations comprising:
implementing an embedder component in a reusable component framework;
implementing an embedded component in the reusable component framework;
mapping a first view area of a first interface view of the embedded component to a second view area of the embedded component; and
providing visual content from the embedder component to the embedded component using the mapped first view area of the interface view of the embedded component and the second view area.

2. The article of claim 1 further comprising:
defining the second view area on a window.

3. The article of claim 1 further comprising:
defining the first view area on the interface view.

4. The article of claim 1 further comprising:
mapping the first view area to the second view area of a window, the second view area mapped to a third view area of a view, the view embedded in the window.

5. The article of claim 1 further comprising:
selecting the embedder component from a plurality of components.

6. The article of claim 1 further comprising:
selecting the embedded component from a plurality of components.

7. The article of claim 1 further comprising:
mapping the first view area and the second view area by graphically linking the first and second view areas.

8. The article of claim 1, further comprising:
defining the interface view of the embedded component as an interface configured to pass view content.

9. A computer-implemented method comprising:
implementing an embedder component in a reusable component framework;
implementing an embedded component in the reusable component framework;
mapping a first view area of a first interface view of the embedded component to a second view area of the embedded component; and
providing visual content from the embedder component to the embedded component using the mapped first view area of the interface view of the embedded component and the second view area.

10. The computer-implemented method of claim 9 further comprising:
defining the second view area on a window.

11. The computer-implemented method of claim 9 further comprising:
defining the first view area on the interface view.

12. The computer-implemented method of claim 9 further comprising:
mapping the first view area to the second view area of a window, the second view area mapped to a third view area of a view, the view embedded in the window.

13. The computer-implemented method of claim 9 further comprising:
selecting the embedder component from a plurality of components.

14. The computer-implemented method of claim 9 further comprising:
selecting the embedded component from a plurality of components.

15. The computer-implemented method of claim 9 further comprising:
mapping the first view area and the second view area by graphically linking the first and second view areas.

16. The computer-implemented method of claim 9, further comprising:
defining the interface view of the embedded component as an interface configured to pass view content.

17. A system comprising:
a processor; and
a memory, wherein the processor and the memory are configured to perform a method comprising:
implementing an embedder component in a reusable component framework;
implementing an embedded component in the reusable component framework;
mapping a first view area of a first interface view of the embedded component to a second view area of the embedded component; and
providing visual content from the embedder component to the embedded component using the mapped first view area of the interface view of the embedded component and the second view area.

18. The system of claim 17 further comprising:
defining the second view area on a window.

18. The system of claim 17 further comprising:
defining the first view area on the interface view.

19. The system of claim 17 further comprising:
mapping the first view area to the second view area of a window, the second view area mapped to a third view area of a view, the view embedded in the window.

20. The system of claim 17 further comprising:
selecting the embedder component from a plurality of components.
